(19) United States
(12) Patent Application Publication
(10) Pub. No.: US 2023/0071652 A1
(43) Pub. Date: Mar. 9, 2023

(54) DEVICE AND METHOD FOR NEUROMUSCULAR STIMULATION

(71) Applicant: Mark SMITH, Palo Alto, CA (US)

(72) Inventor: Mark Smith, Palo Alto, CA (US)

(21) Appl. No.: 17/801,609

(22) PCT Filed: Mar. 1, 2021
(86) PCT No.: PCT/US2021/020229

§ 371 Date: Aug. 23, 2022

Related U.S. Application Data
(60) Provisional application No. 62/982,234, filed on Feb. 27, 2020.

(51) Int. Cl. A61H 21/00

(52) U.S. Cl. CPC A61H 21/00; A61H 2201/1253; A61H 2203/0418; A61H 2205/087

(57) ABSTRACT

A device and method for assisting persons in achieving erection-optional orgasm, the device comprising an articulating base component which acts as a riser, a penetration component attached to the base component, shaft, tip, depth control means for controlling the depth of the penetration, and method for using the device.

### CROSS-REFERENCE TO RELATED DOCUMENTS

The present invention claims priority to a U.S. Provisional Pat. Application Serial No. 62/982,234 entitled Positional Base, Depth Control and Tap filed on Feb. 27, 2020 disclosure of which is included herein at least by reference.

### TECHNICAL FIELD

The present invention is in the field of biomechanics, neuromuscular stimulation and sexual health.

### BACKGROUND ART

Sexual health aids intended to help males achieve orgasm generally focus on devices and methods for stimulating the penis or otherwise entail use of electrified vibratory mechanisms for anal penetration. However, such methods and devices have limitations for assisting the user in achieving erection optional orgasms which are the quickest path to multiple orgasms.

### SUMMARY OF THE INVENTION

A device and method of use for assisting adult males in achieving erection-optional orgasm, the device comprising an articulating base which acts as a riser, a penetration device attached to the base, and a depth control means for controlling the depth of the penetration. The method of use consists of the following steps:

### BRIEF DESCRIPTION OF THE SEVERAL VIEWS OF THE DRAWINGS

FIG. 1 is a side perspective view of the device in position on a floor and up against a vertical wall the user’s lower legs in view.

FIG. 2 is a side perspective view of the device of FIG. 1 showing the user sliding down the vertical wall toward the device.

FIG. 3 is a side perspective view of the device of FIG. 1 penetrating the user’s anal cavity.

FIG. 4 is a side perspective view of the devices of FIG. 1 with the user reaching the depth control device which prevents further penetration into the user’s body cavity.

FIG. 5 is a front perspective view of the user and device in the position shown in FIG. 4.

FIG. 6 is a side perspective view of the user and device showing in user and device in the position shown in FIG. 4 with sectioned cutaway of the user’s internal anatomy.

### DETAILED DESCRIPTION OF THE INVENTION

The present invention is directed to devices and methods for assisting adult males in achieving erection-optional orgasm, more specifically without use of electrified mechanical devices. The following description provides representative embodiments only, and is not intended to limit the scope, applicability or configuration of the disclosure. Rather the description of the embodiment(s) will provide those skilled in the art with an enabling description for implementing an embodiment or embodiments of the invention. It should be understood that various changes can be made in the function and arrangement of elements without departing from the spirit and scope as set forth in the claims. Accordingly, an embodiment is an example or implementation of the invention and not the sole implementation. Various appearances of “one embodiment”, “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, some embodiments”, or “other embodiments” means that a particular feature, structure, or characteristic described in connection with the embodiments is included in at least one embodiment, but not necessarily all embodiments, of the invention. The phraseology and terminology employed herein is not to be construed as limiting but is for descriptive purpose only. It should be understood that where the claims or specification refer to “a” or “an” element, such reference is not to be construed as there being only one of that element. It should be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or elements within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise the phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “user” as used herein, and throughout this disclosure, refers to an individual engaging a device according to embodiments of the invention wherein the engagement is a result of their personal use of the device or use with the assistance of another.

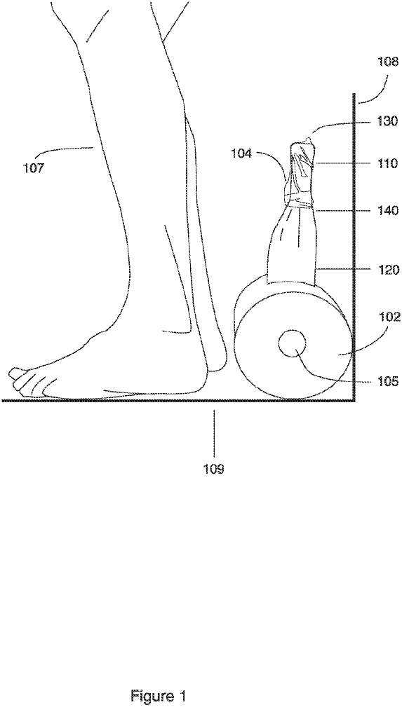

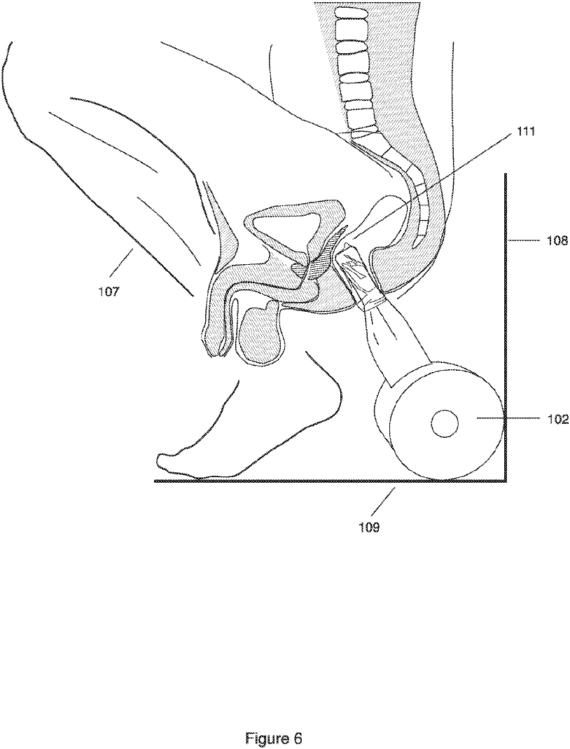

Referring now to FIG. 1, the device consisting of a penetration component 100 having a shaft 110, depth control collar 140, base portion 120 and tip portion 130. The depth control collar 140 widens in a taper from the shaft to the base 120. The embodiment of the penetration component 100 is shown mounted onto a roll 102 as shown. The device in FIG. 1 is placed against a wall 108 and on a floor 109. The wall 108 and floor 109 need not be a wall and floor as long as the wall and floor support the body weight of the user 107. A toilet has a wall which is the tank and the floor is the bowl with seat down. The invention does require that the roll 102 and the user 107 be stabilized by the support of a wall 108 and floor 109. Alternatively, the user may opt to stabilize themselves without the use of a wall and floor by creating fives points of contact with a surface comprised of both knees and both feet and the device. The penetration component 100 has been fitted into a roll 102 which is in the form of a cylinder which allows the user 107 rotate the roll around the X-axis through the center of the roll. The rotation of the roll 102 rotates the penetration component 100 between 10 and 3 on a clock face which allows precise control of the tip 130. Since the internal body is made of soft tissue the parts which require stimulation can be in slightly different places. An angle that worked five minutes ago might not stimulate the optimal spot until an angle adjustment is made. Additionally, The rotation also allows the user to create gentle rhythmic rocking or pumping motions similar to a rocking chair or dampener. There is an expanded section 130 at the tip of the penetration component 100 which upon insertion facilitates with the tapping of the nerves around pubococcygeus muscle region 111 shown in FIG. 6. This enables the user 107 to stimulate, or “tap out” the orgasms at regular intervals, for example every two to three minutes, when used in concert with manipulation of the glans. The top portion of the penetration component 100 has latex barrier 104 which may commonly referred to as a condom as a protective cover. The roll 102 has a finger hole 105 which allows the invention to be picked up and held by the user while still inserted in the user’s 107 body cavity.

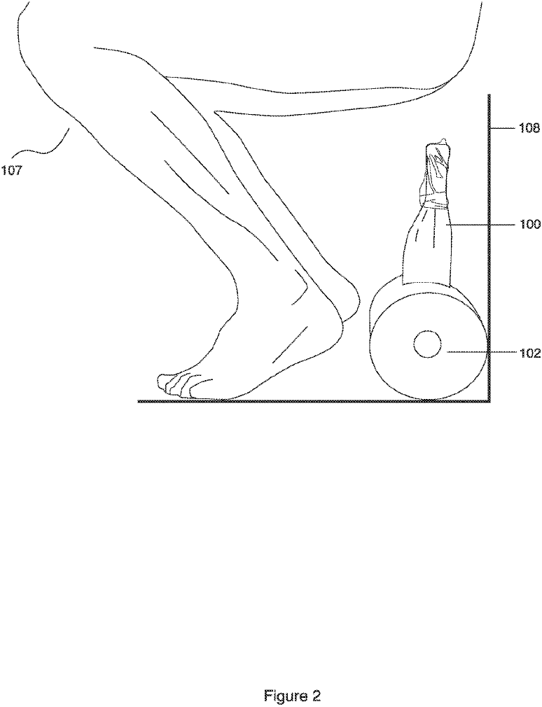

FIG. 2 shows the same device 100 with the user 107 sliding down the wall 108 into a squat to approach insertion of the penetration component 100.

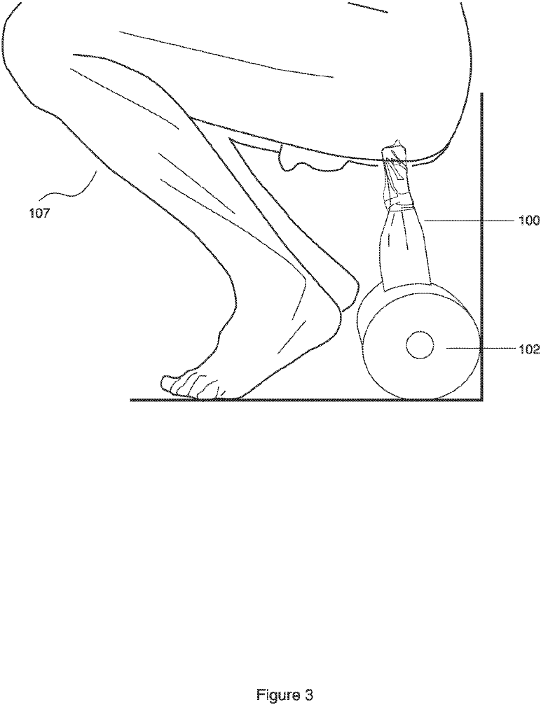

FIG. 3 shows the invention wherein the penetration component 100 is partially inserted into the body cavity of the user 107 in a more advance squat position and the penetration component 100 has rotated forward to better fit the body cavity of the user 107.

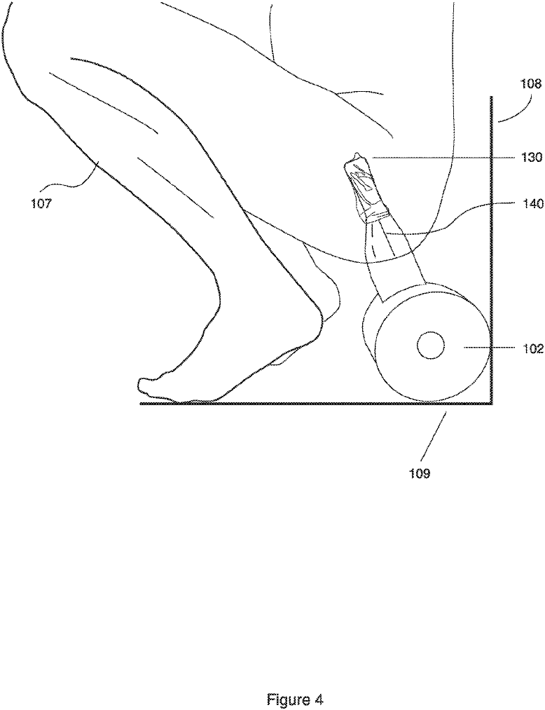

FIG. 4 shows the penetration component 100 of the device fully inserted in the user 107, the depth control collar 140 preventing any further travel of the penetration component into the body cavity. The tip 130 should now be in contact with the user’s 107 nerve endings which surround the pubococcygeus muscle and nerves 111.

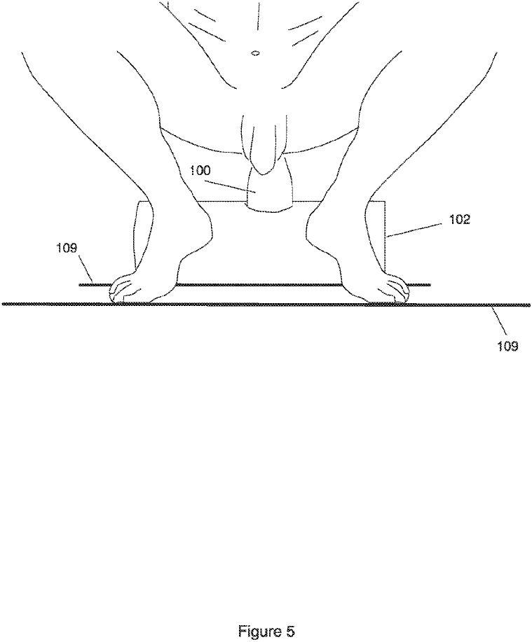

FIG. 5 is front view of the roll 102, the penetration component 100 and the user 107 in a squat position.

FIG. 6 is a body section cutaway in the side view of device at full penetration into the user with the depth control collar 140 preventing any further travel of the penetration component into the body cavity. The tip 130 should now be in contact with the user’s 107 nerve endings which surround the pubococcygeus muscle region 111. The roll 102 may be rotated around the X axis in a rocking motion to facilitate tapping out the orgasms at time intervals, for example every two minutes, although the user’s body will dictate to some degree the length of time between orgasms.

As shown in the Figures, the penetration component 100 is attached with a roll 102. In some embodiments, the penetration component 100 may be used with a sphere shaped, as opposed to cylindrical shaped, base-type or stabilizing component which allows movement in more than one direction, for example in multiple directions in addition to along the x-axis allowed by the roll 102 embodiment. The penetration component 100 may be custom fitted for for shape and size by the user. The embodiment of the penetration component 100 shown in the figures is just one of many alternative embodiments allowing for insertion into the human cavity shown in FIG. 6. The penetration component 100 may have a number of alternative shapes effective for insertion, many of which are known in the art. As the human body varies somewhat in proportion and sensitivity, the user 107 may want the penetration component 100 to be custom fitted.

As previously discussed, the roll 102 is just one embodiment of the component in with which the penetration component 100 may be attached. The roll 102 is just one example embodiment of a “base” or foundation upon which to effectively mount the penetration component 100 and allow for easier insertion of the penetration component 100 in the user 107 as well as allowing focused or controlled movement of the tip 130 of the penetration component 100 against muscles and nerves to assist in stimulating orgasm. For example, an alternative embodiment of the roll 102 component may be spherical in form, allowing multi-axis articulation during use. Another embodiment of the roll 102 may be a roller or tube design allowing for single x-axis articulation. Another embodiment of the roll 102 may be an hexadecagon tube design allowing for fixed position x-axis articulation.

The penetration component 100 may be made out of a variety of materials known in the art. For example, it may be made of polyethylene foam (PE), ethylene vinyl acetate (EVA), high density ethylene vinyl acetate, expanded propylene, wood, metal or a combination of such materials including other materials generally known by a person knowledgeable of the art. Alternative embodiments of the base portion 120 of the penetration component 100 may include a tension based joint or even a lockable joint which would typically be made of metal, aluminum, steel, titanium or carbon fiber. The means for attaching the penetration component 100 to the roll 102 (or stabilizing base) may be, for example, a tension fit hole or alternatively a hole with an adjustable knob attached to a screw running perpendicular to the hole for more secure attachment. In another embodiment, the attachment means consists of a quick release mechanism having spring loaded ball bearings which compress and lock around a bored out ring in the shaft 120 portion of the penetration component 100.

The collar portion 140 of the penetration component 100 has a number of functions including a safety function of effectively preventing the penetration component 100 from penetrating too far into the user 107 during use. The collar 140 may also have a graded, textured, or widening component that allows the user 107 to feel when there is complete penetration or the degree of penetration (for example, upon partial, half or complete insertion). Depending on such use, the collar portion 140 may continue up the shaft from the base portion 120. Again, there are a number of alternative collar portion 140 embodiments including but not limited to a having a tapered section, platform, ring, or textured section. In order to provide preferred safety capabilities, the collar may be wider than the potential stretch of the user’s sphincter. Since the collar 140 also functions to stimulate the erogenous zone around the user’s perineum and provides pressure. The safety measures work in tandem to make sure that the user does not press the penetration component so far as to create injury or unwanted pain. Preferred embodiments of the collar 140 may be made of silicone material which tapers and acts as a gasket between hole or flute in the stabilizing portion (shown in one embodiment as a roll 102) which accepts the penetration component 100 of the device.

In alternative embodiments of the device, the penetration component 100 features adjustability as opposed to the fixed share length and fixed tapered collar embodiment shown in the Figures. One such alternative embodiment consists of a polyethylene foam roll 102 with a hole bored in the center of the horizontal length of the foam roll 102. A flute which is wider at the base than at the opening at the top is inserted into the hole, the hole in the polyethylene foam base being slightly smaller than the flute base so that the flute base may be retained by the expansion due to the compression deflection of the polyethylene foam roll. The flute acts as repository to insert the base and shaft of the penetrating component in a manner consistent with how a syringe works. The shaft as in a syringe is smaller than the flute and so the shaft is able to be inserted into the flute. The flute is similar to a champagne flute without the stem except that it has a flat bottom. A spacer may be inserted into the flute to enable the shaft length to be adjusted as it protrudes out of the flute. The top edge of the flute may be rounded to act as a collar. This alternative embodiment is similar to what you would see in an automobile suspension dampener or when you add an adjustable extension to a vacuum cleaner. Tripod legs also feature a similar sleeve structure as do candle holders. In this embodiment, the collar is a flute like sleeve and the top portion features a silicon gasket which helps center the shaft and provide a cushion for the sphincter and perineum of the user. A condom may be placed over the shaft and the collar will hold it in place while in use.

As one familiar with the art will appreciate, additional alternative embodiments of the invention may include, for example, 1) a penetration component having numerous tapered shapes and penetration lengths, 2) a stabilizing base consisting of a foam roller with hole with shaft for stabilization of the penetration component when inserted, 3) the foam roll itself being the base of the penetration component, 4) the foam roll itself being the base of the penetration component wherein the base is anchored against a 90 degree construct which would not collapse or tip over due to the body weight of the user, 5) a penetration component having modified shaft and tips of various sizes, textures, shapes and made of various materials known in the art, 6) reshaping the various components so that they resemble designs that they would be less easily associated with a sexual stimulation device, 7) modifying the stabilization base by size or materials to allow for use by individuals having different body weights or which might be more easily utilized by persons having disabilities, and 8) using materials or adding functions which facilitate easy cleanup.

The above described invention is primarily intended to assist the user in achieving sexual climax without requiring the user to first obtain penile erection. This method is particularly useful for persons who are unable to obtain an erection for various reasons. An added benefit of use is that the invention enables the user, in most cases, to obtain multiple orgasms in a relatively short period of time. In some cases, the orgasm refractory period may be within a few minutes or seconds. Sexual climax releases neurochemicals in humans which help enhance brain health, immune response and have been linked to decreased stress and increased creativity and productivity. The following is a description of steps for using the above describe device - note that not all steps are necessary. The first step is to prepare for use. As the user’s heart rate is likely to increase substantially during use, it is helpful that the user be in good health for safety purposes. It is helpful for the user to utilize a safe and private environment, keep sanitary aids (such as toilet paper or wipes) readily at hand, use topical ointments for lubrication or otherwise utilize a silicon coated embodiment of the penetration device, make sure the flooring is suitable and preferably non-slip (use of rug, carpet, towel or protective sheeting underneath the device is helpful), and the user should empty his bowels before use. The second step is to prepare the device by rolling a condom onto the shaft and secure the base of the collar. The collar will prevent the device from being inserted too far into the user’s anal cavity and otherwise provides stimulation to the perineum erogenous zone of the user. Next, the user places the device at an appropriate location to allow for stability and function. For example, the user may place the device at the intersection of a wall and the floor to provide a place of support. Next, with feet planted firmly and using a wall or other support for stability, the user squats toward the device and inserts the penetration component into his rectum slowly. Next, the user positions the tip of the penetration through sphincter and 3 to 5 inches into the rectal region to locate the pleasure center. The pleasure center may shift during the 3 minutes of stimulation which is why easy articulation of the base is necessary. A considerable amount of pressure also needs to be applied to the pelvic floor and this cannot be done safely without the base and collar combination. Next the user manipulates the sensitive portion of his glans until reaching climax, resting where necessary and then continuing as desired. When completed, the user removes the penetration component from the anus and cleans up.

It should be noted that the invention described herein is not limited to the use of assisting in achieving orgasm. The device also provides massage function to prostate and may be used to exercise and strengthen the pelvic floor. The device is not limited to males and may be useful to female and transsexual and transgender populations. Of note: humans who identify as female engage in vaginal and anal penetrative sex and their pleasure consists of a mix of penetration and stimulation of the glans and pubic region. Of further note: there is a zero risk of pregnancy or sexual disease transmission when using this device and it may be used solo or with a partner

The foregoing disclosure of the embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims and their equivalents.

1. A device for penetration comprising a penetration component attached with an articulating base component, the penetration component having a base, shaft, tip and depth control collar.
